(19) United States
(12) Patent Application Publication
(10) Pub. No.: US 2015/0379917 A1
(43) Pub. Date: Dec. 31, 2015

(54) METHOD FOR COMPENSATING GRAY SCALE VOLTAGE AND DISPLAY DEVICE

(71) Applicant: SHENZHEN CHINA STAR OPTOELECTRONICS TECHNOLOGY CO. LTD., Shenzhen (CN)

(72) Inventors: Lei Sun, Shenzhen (CN); Xiaoping Tan, Shenzhen (CN); Jiehui Qin, Shenzhen (CN)

(21) Appl. No.: 14/416,289

(22) PCT Filed: Aug. 26, 2014
(86) PCT No.: PCT/CN2014/085213

§ 371 Date: Jan. 22, 2015

(30) Foreign Application Priority Data
Jun. 27, 2014 (CN) 201410301945.7

(51) Int. Cl. G09G 3/20; G09G 3/36

(52) U.S. Cl. CPC G09G 3/2074; G09G 3/3607; G09G 2320/0271

(57) ABSTRACT

A method for compensating gray scale voltage and a display device is provided. The method and the display belong to the technical field of display and can solve the technical problem of cross-color in the prior art. The method for compensating gray scale voltage comprises: step A, acquiring a target gray scale voltage to be outputted by a target sub pixel, step B: acquiring a compensating voltage of the target sub pixel based on preset conditions, and step C: acquiring an actual gray scale voltage by adding the target gray scale voltage and the compensating voltage together, and outputting the actual gray scale voltage to the target sub pixel. The present disclosure is applicable to display devices such as liquid crystal television, liquid crystal display device, cell phone, and tablet PC, etc.

The present application claims benefit of Chinese patent application CN 201410301945.7, entitled “Method for Compensating Gray Scale Voltage and Display Device” and filed on Jun. 27, 2014, which is incorporated herein by reference.

### TECHNICAL FIELD

The present disclosure relates to the technical field of display technology. Specifically, it relates to a method for compensating gray scale voltage, and a display device.

### TECHNICAL BACKGROUND

With the development of display technology, liquid crystal display has become a commonly used panel display device. In a liquid crystal display, the pixels each are controlled by gate lines and data lines which are arranged in a staggered manner on a substrate, so as to display images.

In a displaying process of the liquid crystal display, the scan lines (gate lines) are successively enabled. During the time period that one scan line is enabled (one scanning period), the data lines each input gray scale voltages into pixel electrodes of the sub pixels in this line. During the next scanning period, the data lines each input gray scale voltages into the pixel electrodes of sub pixels in the next line.

With respect to one of the data lines, it inputs respective gray scale voltages to the pixel electrodes of two adjacent sub pixels in the column within two adjacent scanning periods; that is, the voltage of the data line changes from the gray scale voltage of the previous sub pixel into that of the latter sub pixel within the latter scanning period. However, when the difference between the gray scale voltages of the two sub pixels is relatively large, it is very difficult for the voltage of the data line to change from the gray scale of the previous sub pixel into that of the latter sub pixel within the latter scanning period. This will cause cross-color on the latter sub pixel, thereby affecting the display effect of the liquid crystal display device.

### SUMMARY OF THE INVENTION

The present disclosure aims to provide a method for compensating gray scale voltage and a display device, in order to solve the technical problem of cross-color existing in the prior art.

The present disclosure provides a method for compensating gray scale voltage, comprising:

step A: acquiring a target gray scale voltage to be outputted by a target sub pixel,

step B: acquiring a compensating voltage of the target sub pixel based on preset conditions, and

step C: acquiring an actual gray scale voltage by adding the target gray scale voltage and the compensating voltage together, and outputting the actual gray scale voltage to the target sub pixel.

Preferably, in step B,

the compensating voltage of the target sub pixel is acquired based on the target gray scale voltage and a previous gray scale voltage,

wherein the previous gray scale voltage is an actual gray scale voltage outputted by a data line corresponding to the target sub pixel in a previous scanning period.

Further, step B comprises:

acquiring the compensating voltage of the target sub pixel by looking up in a compensating voltage comparison table based on the target gray scale voltage and the previous gray scale voltage.

Further, in step B,

the compensating voltage of the target sub pixel is acquired according to the location of the target sub pixel, as well as the target gray scale voltage and the previous gray scale voltage,

wherein the previous gray scale voltage is an actual gray scale voltage outputted by a data line corresponding to the target sub pixel in the previous scanning period.

Preferably, step B comprises:

determining a compensating voltage comparison table corresponding to the target sub pixel among a plurality of compensating voltage comparison tables according to the location of the target sub pixel, and

acquiring the compensating voltage of the target sub pixel by looking up in said compensating voltage comparison table based on the target gray scale voltage and the previous gray scale voltage.

The present disclosure further provides a display device, comprising:

an input module for acquiring a target gray scale voltage to be outputted by a target sub pixel,

a compensation module for acquiring a compensating voltage of the target sub pixel based on preset conditions, and

an output module for adding the target gray scale voltage and the compensating voltage together to obtain an actual gray scale voltage, and outputting the actual gray scale voltage to the target sub pixel.

Preferably, the compensation module is used for acquiring the compensating voltage of the target sub pixel based on the target gray scale voltage and a previous gray scale voltage,

wherein the previous gray scale voltage is an actual gray scale outputted by a data line corresponding to the target sub pixel in a previous scanning period.

Further, the compensation module comprises:

a memory for storing a compensating voltage comparison table,

a voltage determination unit for determining the target gray scale voltage and the previous gray scale voltage, and

a query unit for acquiring the compensating voltage of the target sub pixel by looking up in the compensating voltage comparison table based on the target gray scale voltage and the previous gray scale voltage.

Preferably, the compensation module is use for acquiring the compensating voltage of the target sub pixel based on the location of the target sub pixel as well as the target gray scale voltage and the previous gray scale voltage,

wherein the previous gray scale voltage is an actual gray scale outputted by a data line corresponding to the target sub pixel in the previous scanning period.

Further, the compensation module comprises:

a memory for storing a plurality of compensating voltage comparison tables,

a location determination unit for determining the location of the target sub pixel,

a voltage determination unit for determining the target gray scale voltage and the previous gray scale voltage, and

a query unit for determining a corresponding compensating voltage comparison table of the target sub pixel according to the location of the target sub pixel, and acquiring the compensating voltage of the target sub pixel by looking up in the compensating voltage comparison table based on the target gray scale voltage and the previous gray scale voltage.

The present disclosure achieves the following favorable effects. In the method for compensating gray scale voltage and the display device according to the present disclosure, a target gray scale voltage to be outputted by a target sub pixel is acquired, then a compensating voltage is acquired based on preset conditions such as a previous gray scale voltage, furthermore, an actual gray scale voltage is obtained by adding the target gray scale voltage and the compensating voltage together and is outputted to a pixel electrode of the target sub pixel. In this case, the actual gray scale voltage of the pixel electrode of the target sub pixel can be equal to the target gray scale voltage, thereby solving the technical problem of cross-color.

Other features and advantages of the present disclosure will be further explained in the following description and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

In order to clarify the technical solutions of the embodiments of the present disclosure, the drawings relating to the embodiments will be explained briefly. In which:

FIG. 1 schematically shows a driver of a display device according to example 1 of the present disclosure;

FIG. 2 schematically shows the sub regions of a display device according to example 2 of the present disclosure; and

FIG. 3 schematically shows a driver of the display device according to example 2 of the present disclosure.

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It is important to note that as long as there is no structural conflict, all the technical features mentioned in all the embodiments may be combined together in any manner, and the technical solutions obtained in this manner all fall within the scope of the present disclosure.

### EXAMPLE 1

The present disclosure provides a method for compensating gray scale voltage, so as to solve the technical problem of cross-color during the operation of a liquid crystal display device. The method for compensating gray scale voltage comprises the following steps:

step A: acquiring a target gray scale voltage to be outputted by a target sub pixel; and

step B: acquiring a compensating voltage of the target sub pixel based on preset conditions.

In example 1, the preset conditions in step B refer to the difference between the target gray scale voltage and a previous gray scale voltage. That is, in step B, the compensating voltage of the target sub pixel is acquired based on the target gray scale voltage and the previous gray scale voltage. The previous gray scale voltage is an actual gray scale voltage outputted by a data line corresponding to the target sub pixel in a previous scanning period, i.e., a gray scale voltage of a previous sub pixel in the column of the target sub pixel. If the target sub pixel is located at the first line of a column, the previous gray scale voltage refers to the gray scale voltage of the last sub pixel of this column.

Specifically, a compensating voltage comparison table as shown in Table 1 can be established in advance.

TABLE 1

| | P1 | | | | | | | |
|---|---|---|---|---|---|---|---|---|
| P2 | 0 | 8 | 16 | 32 | 64 | 127 | 192 | 255 |
| 0 | 0 | 0 | 0 | 0 | 0 | 0 | 0 | 0 |
| 8 | 10 | 0 | −4 | −5 | −11 | −12 | −24 | −24 |
| 16 | 10 | 8 | 0 | −6 | −12 | −23 | −22 | −23 |
| 32 | 11 | 9 | 5 | 0 | −10 | −20 | −20 | −12 |
| 64 | 12 | 10 | 10 | 20 | 0 | −12 | −10 | −11 |
| 127 | 13 | 20 | 15 | 24 | 0 | 0 | −9 | −10 |
| 192 | 14 | 30 | 20 | 25 | 10 | 40 | 0 | −6 |
| 255 | 0 | 0 | 0 | 0 | 0 | 0 | 0 | 0 |

In said compensating voltage comparison table, the first line P1 represents the gray scale voltage of a previous sub pixel in the column of the target sub pixel, the first column P2 represents the target gray scale voltage of the target sub pixel, and the rest values of the table represent the corresponding compensating voltages when P1 and P2 each are of different values. It should be noted that because the scanning in a liquid crystal display device occurs line by line, in two adjacent scanning periods, P1 in a latter scanning period is the P2 of a previous scanning period.

After the compensating voltage comparison table is established, in step B, the compensating voltage of the target sub pixel can be acquired by looking up in said compensating voltage comparison table based on the target gray scale voltage and the previous gray scale voltage.

For example, according to the compensating voltage comparison table, when the target gray scale voltage of a target sub pixel is 64 level and the previous gray scale voltage is 16 level, the compensating voltage is 10.

The method further comprises step C: acquiring an actual gray scale voltage by adding the target gray scale voltage and the compensating voltage together, and outputting the actual gray scale voltage to the target sub pixel.

The gray scale voltage of 64 is added to the compensating voltage of 10, so that an actual gray scale voltage of 74 level can be obtained, and the actual gray scale voltage of 74 level is outputted to the target sub pixel. Thus, after compensation, the gray scale voltage of the target sub pixel can reach 64 level, thereby solving the technical problem of cross-color.

Each of the values of the compensating voltages in the compensating voltage comparison table can be acquired through experiments. In example 1, the dimension of the compensating voltage comparison table is 8×8, including altogether 64 compensating voltages. When P1 and P2 each are of other values, the corresponding compensating voltages can be obtained by means of linear interpolation method. For example, it is known that when P1=32 and P2=16, the compensating voltage is −6, and when P1=64 and P2=16, the compensating voltage is -12, thus when P1=48 and P2=16, a compensating voltage of −9 can be obtained through linear interpolation method.

In other embodiments, the dimension of the compensating voltage comparison table can be 16×16 or others. Thus, the compensating voltages when P1 and P2 each are of different values can be obtained through linear interpolation method. In this case, the memory space for storing the compensating voltage comparison table can be saved, the cost thereof can be reduced, and the procedure of establishing the compensating voltage comparison table can be simplified.

The present disclosure further provides a display device, in particular liquid crystal television, liquid crystal display device, cell phone, and tablet PC, etc. The display device comprises a liquid crystal panel, and a driver which drives each sub pixel unit in the liquid crystal panel to display images.

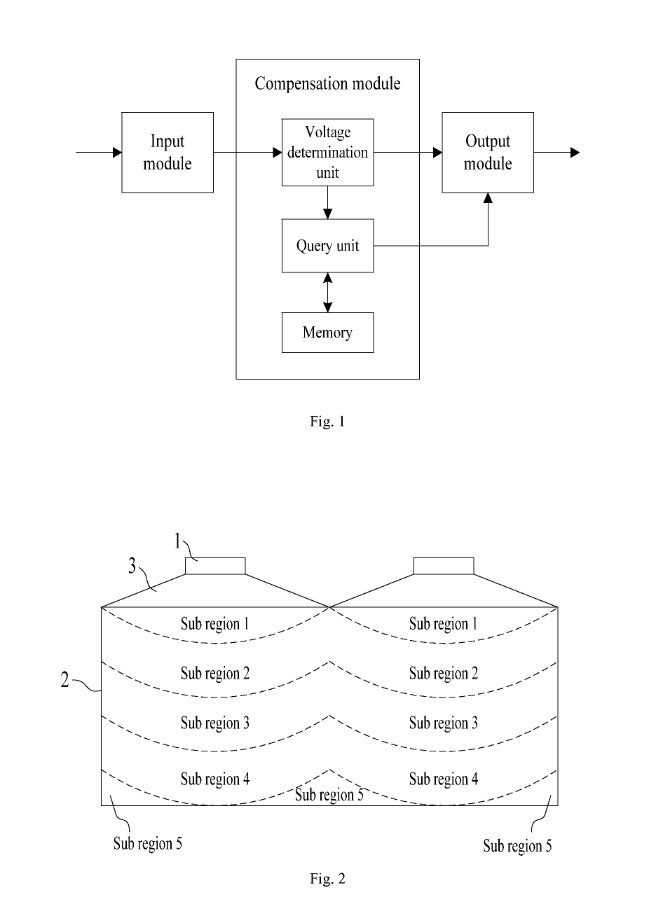

As shown in FIG. 1, the driver, which is designed based on a field programmable gate array (abbr. FPGA), comprises an input module, a compensating module, and an output module.

The input module is used for acquiring a target gray scale voltage to be outputted by a target sub pixel.

The compensating module is used for acquiring the compensating voltage of the target sub pixel based on preset conditions. In example 1, the preset condition refers to the difference between the target gray scale voltage and a previous gray scale voltage; that is, the compensating module acquires a compensating voltage of the target sub pixel based on the target gray scale voltage and the previous gray scale voltage. Specifically, the compensating module comprises a memory, a voltage determination unit, and a query unit.

The memory stores compensating voltage comparison tables (such as Table 1). The voltage determination unit is used for determining the target gray scale voltage and the previous gray scale voltage. The query unit is used for acquiring the compensating voltage of the target sub pixel by looking up in a compensating voltage comparison table based on the target gray scale voltage and the previous gray scale voltage.

For example, the target gray scale voltage to be outputted by a target sub pixel which is acquired by the input module is 64 level. The voltage determination unit determines that the target gray scale voltage of the target sub pixel is 64 level, and the previous gray scale voltage is 16 level. In this case, the query unit looks it up in the compensating voltage comparison table in the memory, and obtains a compensating voltage of 10.

The output module adds the target gray scale voltage of 64 and the compensating voltage of 10 together, thereby obtaining an actual gray scale voltage of 74. Then the output module outputs the actual gray scale voltage of 74 to the target sub pixel, thereby solving the technical problem of cross-color.

### EXAMPLE 2

Example 2 provides a method for compensating gray scale voltage, which is substantially the same as that in example 1. The difference of the method in example 2 from that in Example 1 is that the preset conditions in step B further comprise the location of a target sub pixel.

As shown in FIG. 2, because a data integrated circuit (IC) 1 for outputting data signals is usually disposed above a liquid crystal panel 2, the nearer to the bottom of the liquid crystal panel 2 a sub pixel is, the farther the sub pixel is from the data IC 1, and thus the larger resistance between the sub pixel and the data IC 1, rendering loss of gray scale voltage outputted by the data IC 1 to the sub pixel. Thus the gray scale voltage of the target sub pixel cannot reach the target gray scale voltage.

In particular, the mode with one pixel comprising three sub pixels which are respectively disposed in three rows and form one column (hereinafter referred to 3G1D mode) has a longer data line as compared with the mode with one pixel comprising three sub pixels which are disposed in three columns and form one row (hereinafter referred to as 1G3D mode). As a result, in the 3G1D mode, the resistance between the sub pixel near the bottom of the liquid crystal panel 2 and the data IC 1 is larger, thus the loss of gray scale voltage is more evident.

Therefore, in example 2, compensation of the loss of gray scale voltage caused by the resistance between a sub pixel and the data IC 1 is further implemented.

Because the farther a sub pixel is from the data IC 1, the more loss of gray scale voltage it will suffer, hence the larger the compensating voltage needed. Therefore, the liquid crystal panel 2 are divided into a number of sub regions according to the distances between each of the sub pixels and the data IC 1. In addition, because the data IC 1 is connected to the data lines in the liquid crystal panel 2 through a sector-shape leading wire 3, sub pixels located at the center of the sector-shape leading wire 3 are relatively close to the data IC 1 while sub pixels at the two sides of the sector-shape leading wire 3 are relatively far from the data IC 1. Thus, each sub region appears a shape of a sector. Furthermore, a compensating voltage comparison table is established for each of the sub regions. The farther a sub region is from the data IC 1, the larger the values of compensating voltages in the compensating voltage comparison table corresponding thereto.

In example 2, the liquid crystal panel is divided into five sub regions according to the different distances between each of the sub pixels and the data IC 1. In other embodiments, the number of sub regions can be increased or decreased based on actual situation.

The method according to example 2 comprises the following steps. In which:

Step A: acquiring a target gray scale voltage to be outputted by a target sub pixel.

Step B: acquiring a compensating voltage of the target sub pixel according to the location of the target sub pixel, as well as the target gray scale voltage and a previous gray scale voltage. Step B can in particular include Step B1: determining a compensating voltage comparison table corresponding to the target sub pixel among a plurality of compensating voltage comparison tables according to the location of the target sub pixel. Because five compensating voltage comparison tables corresponding to the five sub regions have been established in advance, in step B1, a corresponding compensating voltage comparison table is determined based on which of the sub regions the target sub pixel is located. Step B can further include Step B2: acquiring the compensating voltage of the target sub pixel by looking up in the compensating voltage comparison table based on the target gray scale voltage and the previous gray scale voltage.

Step C: acquiring an actual gray scale voltage by adding the target gray scale voltage and the compensating voltage together, and outputting the actual gray scale voltage to the target sub pixel.

After compensation, the target sub pixel can obtain an actual gray scale voltage that equals to the target gray scale voltage, thereby solving the technical problem of cross-color.

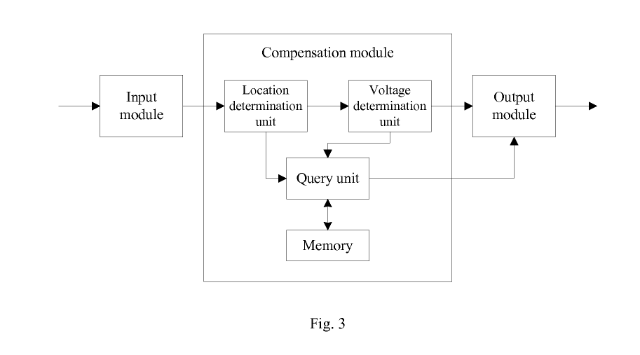

Example 2 further provides a display device which is substantially the same as that in example 1. The display device comprises a liquid crystal panel and a driver. As shown in FIG. 3, the driver comprises an input module, a compensation module, and an output module.

Example 2 is different from example 1 in the following aspects. In example 2, the memory stores five compensating voltage comparison tables respectively corresponding to the five sub regions (as shown in FIG. 2) of the liquid crystal panel. The compensation module is used for acquiring the compensating voltage of the target sub pixel based on the location of the sub pixel as well as the target gray scale voltage and a previous gray scale voltage.

The compensation module further comprises a location determination unit for determining the location of the target sub pixel, in addition to the memory, voltage determination unit, and the query unit. The query unit determines a compensating voltage comparison table among the five compensating voltage comparison tables corresponding to the target sub pixel according to the location of the target sub pixel first, and then acquires the compensating voltage of the target sub pixel by looking up in the compensating voltage comparison table based on the target gray scale voltage and the previous gray scale voltage

For example, the input module acquires a target gray scale voltage to be outputted by the target sub pixel of 64 level.

The location determination unit determines that the target sub pixel is located in sub region 1, and the voltage determination unit determines a target gray scale voltage of the target sub pixel of 64 level and a previous gray scale voltage of 16 level. Then, the query unit determines the compensating voltage comparison table corresponding to the target sub pixel to be a first compensating voltage comparison table based on the fact that the target sub pixel is located at sub region 1. By looking up in the first compensating voltage comparison table, a compensating voltage of 10 of the target sub pixel is obtained.

At last, the output module adds the target gray scale voltage of 64 and the compensating voltage of 10, thereby obtaining an actual gray scale voltage of 74. And the output module outputs the actual gray scale voltage 74 to the target sub pixel. Thus, after compensation, the gray scale voltage of the target sub pixel can reach 64 level, thereby solving the technical problem of cross-color.

The above embodiments are described only for better understanding, rather than restricting, the present disclosure. Any person skilled in the art can make amendments to the implementing forms or details without departing from the spirit and scope of the present disclosure. The scope of the present disclosure should still be subjected to the scope defined in the claims.

1. A method for compensating gray scale voltage, comprising
step A: acquiring a target gray scale voltage to be outputted by a target sub pixel,
step B: acquiring a compensating voltage of the target sub pixel based on preset conditions,
step C: acquiring an actual gray scale voltage by adding the target gray scale voltage and the compensating voltage together, and outputting the actual gray scale voltage to the target sub pixel.

2. The method according to claim 1, wherein in step B, the compensating voltage of the target sub pixel is acquired based on the target gray scale voltage and a previous gray scale voltage,
wherein the previous gray scale voltage is an actual gray scale voltage outputted by a data line corresponding to the target sub pixel in a previous scanning period.

3. The method according to claim 2, wherein step B comprises acquiring the compensating voltage of the target sub pixel by looking up in a compensating voltage comparison table based on the target gray scale voltage and the previous gray scale voltage.

4. The method according to claim 1, wherein in step B, the compensating voltage of the target sub pixel is acquired according to the location of the target sub pixel, as well as the target gray scale voltage and the previous gray scale voltage,
wherein the previous gray scale voltage is an actual gray scale voltage outputted by a data line corresponding to the target sub pixel in the previous scanning period.

5. The method according to claim 4, wherein step B comprises:
determining a compensating voltage comparison table corresponding to the target sub pixel among a plurality of compensating voltage comparison tables according to the location of the target sub pixel, and
acquiring the compensating voltage of the target sub pixel by looking up in said compensating voltage comparison table based on the target gray scale voltage and the previous gray scale voltage.

6. A display device, comprising
an input module for acquiring a target gray scale voltage to be outputted by a target sub pixel,
a compensation module for acquiring a compensating voltage of the target sub pixel based on preset conditions, and
an output module for adding the target gray scale voltage and the compensating voltage together to obtain an actual gray scale voltage, and outputting the actual gray scale voltage to the target sub pixel.

7. The display device according to claim 6, wherein the compensation module is used for acquiring the compensating voltage of the target sub pixel based on the target gray scale voltage and a previous gray scale voltage,
wherein the previous gray scale voltage is an actual gray scale outputted by a data line corresponding to the target sub pixel in a previous scanning period.

8. The display device according to claim 7, wherein the compensation module comprises:
a memory for storing a compensating voltage comparison table,
a voltage determination unit for determining the target gray scale voltage and the previous gray scale voltage, and
a query unit for acquiring the compensating voltage of the target sub pixel by looking up in the compensating voltage comparison table based on the target gray scale voltage and the previous gray scale voltage.

9. The display device according to claim 6, wherein the compensation module is used for acquiring the compensating voltage of the target sub pixel based on the location of the target sub pixel as well as the target gray scale voltage and the previous gray scale voltage,
wherein the previous gray scale voltage is an actual gray scale outputted by a data line corresponding to the target sub pixel in the previous scanning period.

10. The display device according to claim 9, wherein the compensation module comprises:
a memory for storing a plurality of compensating voltage comparison tables,
a location determination unit for determining the location of the target sub pixel,
a voltage determination unit for determining the target gray scale voltage and the previous gray scale voltage, and
a query unit for determining a corresponding compensating voltage comparison table of the target sub pixel among the plurality of compensating voltage comparison tables according to the location of the target sub pixel, and acquiring the compensating voltage of the target sub pixel by looking up in the compensating voltage comparison table based on the target gray scale voltage and the previous gray scale voltage.
